(19) United States
(12) Patent Application Publication
(10) Pub. No.: US 2007/0268314 A1
(43) Pub. Date: Nov. 22, 2007

(54) Graphic data retrieving apparatus, method, and program

(75) Inventor: Yoshihisa Kizuka, Ome-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/798,574

(22) Filed: May 15, 2007

(30) Foreign Application Priority Data
May 17, 2006 (JP) 2006-137940

(51) Int. Cl. G09G 5/00

(52) U.S. Cl. 345/635

(57) ABSTRACT

According to one embodiment, a graphic data retrieving apparatus includes an intermediate buffer which defines a graphic plane and a graphic processing unit which retrieves contents of the intermediate buffer for transfer. The graphic processing unit is configured to store various graphic objects, which should be placed in the graphic plane, in the intermediate buffer as graphic data, partition a drawing area, which serves as part of the graphic plane and is occupied by the graphic data, into a plurality of rectangular areas which do not overlap one another, and retrieves the graphic data from the intermediate buffer for each rectangular area.

### CROSS-REFERENCE TO RELATED APPLICATIONS

This application is based upon and claims the benefit of priority from Japanese Patent Application No. 2006-137940, filed May 17, 2006, the entire contents of which are incorporated herein by reference.

### BACKGROUND

1. Field

One embodiment of the present invention generally relates to video equipment having a graphics-drawing function, and in particular, to a graphic data retrieving apparatus, method, and program which retrieve graphic data from a drawing memory in the video equipment for transfer.

2. Description of the Related Art

Video equipment, for example, a DVD player, has a graphics-drawing function for drawing various graphic objects such as figures, characters, or other images on a graphic plane. Specifically, the graphic plane is defined by a drawing memory, and the graphics-drawing function is used to store the various graphic objects in the drawing memory as graphic data. The graphic data is transferred from the drawing memory, serving as an intermediate buffer, to a frame buffer, and then output from the frame buffer to a display device such as a television in order to actually display a graphic image.

Recently, graphic images have been enhanced in resolutions, and thus the sizes of memories for the drawing memory and frame buffer tend to increase. Even with the increased memory sizes, all the graphic data must be transferred to the frame buffer during a vertical scan period corresponding to an image update period. Various graphic objects often partly overlap one another on the graphic plane. However, the graphic data is normally transferred in units of a drawing area for each graphic object. Consequently, data transfer is redundantly carried out on the overlapping part. This requires an increase in the data transfer bandwidth or data transfer rate, imposing an excessive load on the control system of the video equipment.

Conventionally, there is a method proposed as a countermeasure for reducing the load on the control system. Before data transfer, this method determines whether or not graphic data is present in each arbitrary rectangular area and carries out data transfer for a rectangular area in which graphic data is present, while omitting data transfer for a rectangular area in which graphic data is not present (Jpn. Pat. Appln. KOKAI Publication No. 2002-215562).

However, since this method uses rectangular areas of a fixed size, the drawing area and the rectangular area are likely to differ in size. It is thus difficult to minimize the amount of data transferred according to the shape or size of the graphic object. Further, the above method determines whether or not graphic data is present, before data transfer. This may temporarily increase the load on the control system.

### SUMMARY

According to an embodiment of the present invention, there is provided a graphic data retrieving apparatus comprising a drawing memory which defines a graphic plane and a processing section which retrieves contents of the drawing memory for transfer, wherein the processing section is configured to store various graphic objects, which should be placed in the graphic plane, in the drawing memory as graphic data, partition a drawing area which serves as part of the graphic plane and are occupied by the graphic data, into a plurality of rectangular areas which do not overlap one another, and retrieve the graphic data from the drawing memory for each rectangular area.

According to an embodiment of the present invention, there is provided a graphic data retrieving method for graphic data from a drawing memory which defines a graphic plane, the method comprising storing various graphic objects, which should be placed in the graphic plane, in the drawing memory as graphic data, partitioning a drawing area, which serves as part of the graphic plane and is occupied by the graphic data, into a plurality of rectangular areas which do not overlap one another, and retrieving the graphic data from the drawing memory for each rectangular area.

According to an embodiment of the present invention, there is provided a graphic data retrieving program for graphic data from a drawing memory which defines a graphic plane, the program causing a computer to execute a process of storing various graphic objects, which should be placed in the graphic plane, in the drawing memory as graphic data, partitioning a drawing area, which serves as part of the graphic plane and is occupied by the graphic data, into a plurality of rectangular areas which do not overlap one another, and retrieving the graphic data from the drawing memory for each rectangular area.

With the graphic data retrieving apparatus, method, and program, the various graphic objects which should be placed in the graphic plane are stored in the drawing memory as graphic data, the drawing area which serves as part of the graphic plane and is occupied by the graphic data is partitioned into the plurality of rectangular areas which do not overlap one another, and the graphic data is retrieved from the drawing memory for each rectangular area. This eliminates the need for redundant data transfer and makes it possible to minimize the amount of data transferred according to the shape and size of each rectangular area and the total number of rectangular areas. As a result, the load on the control system can be reliably reduced. Moreover, coordinate information on each rectangular area can be obtained during the partitioning of the drawing area. This also makes it possible to avoid a temporary increase in the load on the control system during data transfer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram schematically showing the circuit configuration of a display system according to an embodiment of the present invention;

FIG. 2 is an exemplary diagram showing, in detail, the configuration of a frame buffer, an intermediate buffer, and a management table shown in FIG. 1;

FIG. 3 is an exemplary diagram showing an initialized state of a bitmap in a bitmap memory shown in FIG. 2;

FIG. 4 is an exemplary diagram showing a state where the bitmap in the bitmap memory shown in FIG. 3 has changed upon drawing of a first graphic object;

FIG. 5 is an exemplary diagram showing a state where the bitmap in the bitmap memory shown in FIG. 4 has changed upon drawing of a second graphic object;

FIG. 6 is an exemplary diagram showing a state where the bitmap in the bitmap memory shown in FIG. 5 has changed upon drawing of a final graphic object;

FIG. 7 is an exemplary diagram showing coordinate information on a first rectangular area which is obtained by searching the bitmap in the bitmap memory shown in FIG. 6 for a set of flags “1”;

FIG. 8 is an exemplary diagram showing coordinate information on a second rectangular area which is obtained by searching the bitmap in the bitmap memory shown in FIG. 6 for a set of flags “1”;

FIG. 9 is an exemplary diagram showing coordinate information on a third rectangular area which is obtained by searching the bitmap in the bitmap memory shown in FIG. 6 for a set of flags “1”;

FIG. 10 is an exemplary diagram showing coordinate information on a fourth rectangular area which is obtained by searching the bitmap in the bitmap memory shown in FIG. 6 for a set of flags “1”;

FIG. 11 is an exemplary diagram showing coordinate information on a fifth rectangular area which is obtained by searching the bitmap in the bitmap memory shown in FIG. 6 for a set of flags “1”;

FIG. 12 is an exemplary diagram showing coordinate information on a sixth rectangular area which is obtained by searching the bitmap in the bitmap memory shown in FIG. 6 for a set of flags “1”; and

FIG. 13 is an exemplary diagram showing coordinate information on a seventh rectangular area which is obtained by searching the bitmap in the bitmap memory shown in FIG. 6 for a set of flags “1”.

### DETAILED DESCRIPTION

Various embodiments according to the invention will be described hereinafter with reference to the accompanying drawings.

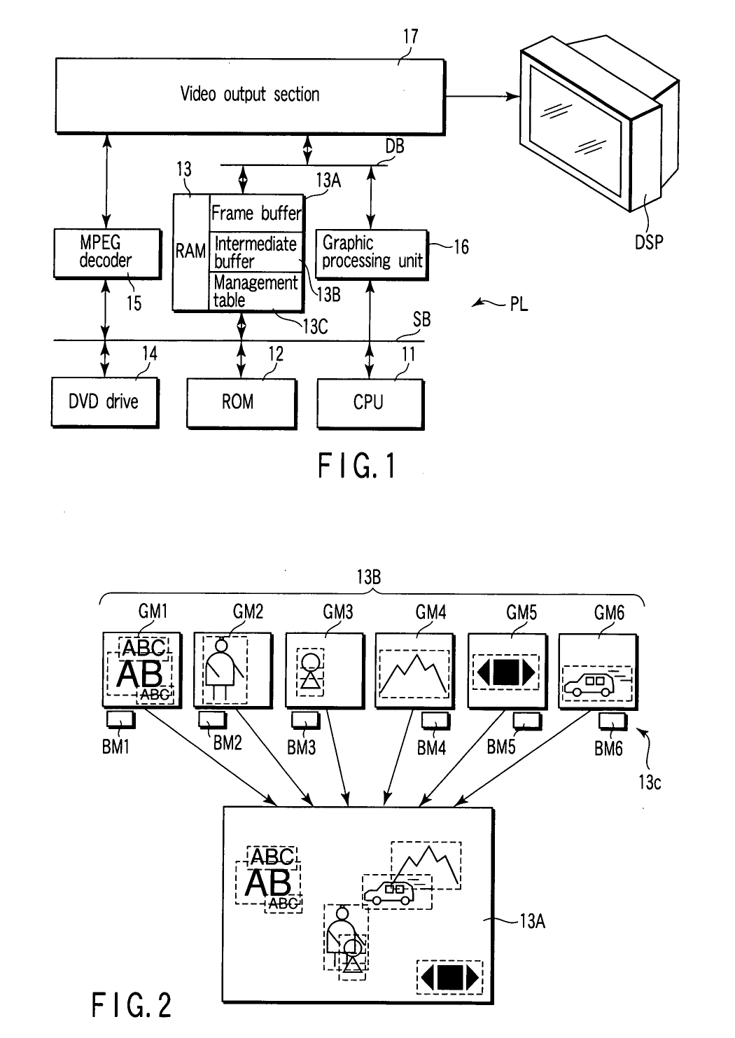

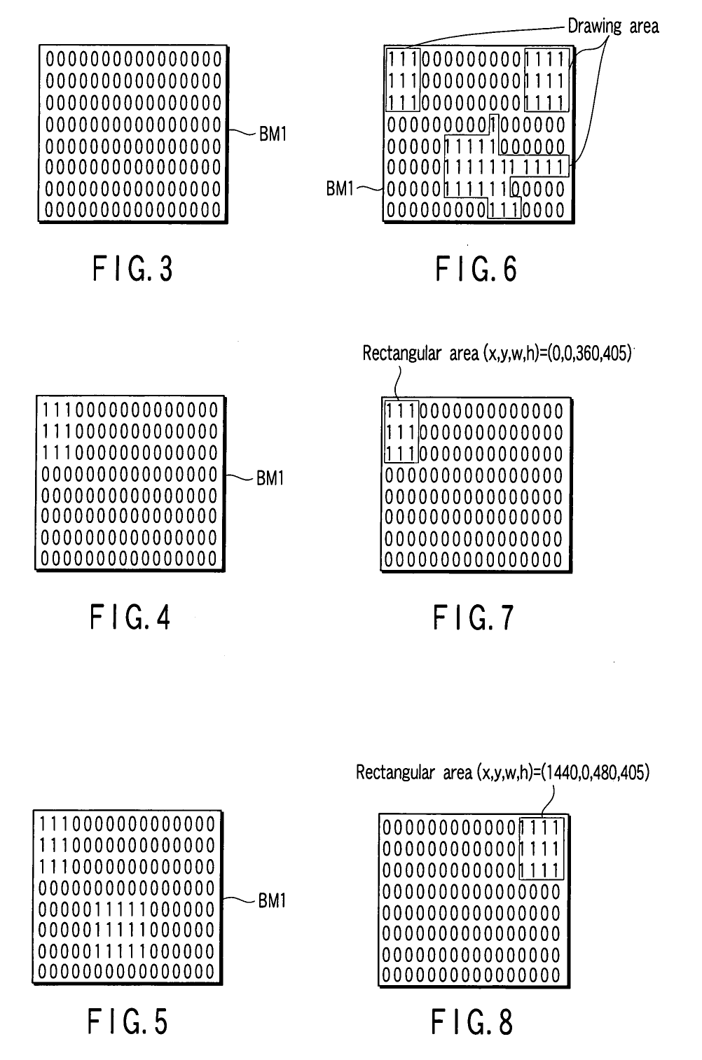

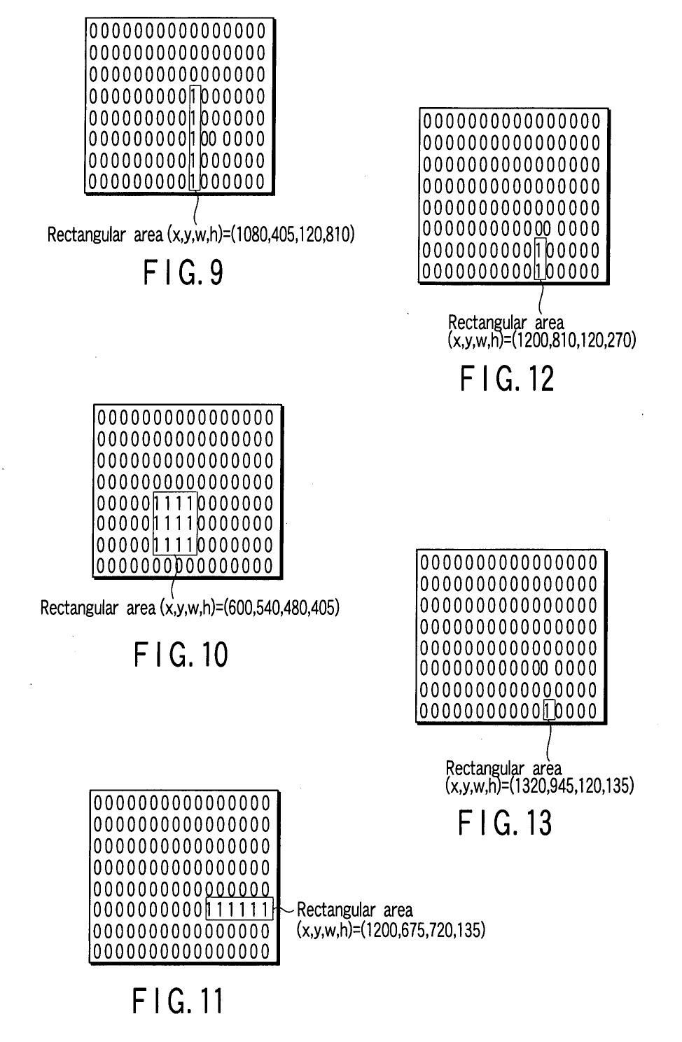

FIG. 1 schematically shows the circuit configuration of a display system according to an embodiment of the present invention. The display system includes a DVD player PL serving as video equipment and a display device DSP such as a television which displays graphic images in accordance with to a video signal from the DVD player PL. FIG. 1 shows the DVD player PL independently of the display device DSP. However, the DVD player PL may be incorporated into a case of the display device DSP.

The DVD player PL has a CPU 11, ROM 12, RAM 13, DVD driver 14, MPEG decoder 15, and graphic processing unit 16 which are interconnected via a system bus SB.

The CPU 11 controls the operation of the whole DVD player PL. ROM 12 holds fixed data and various programs to be executed by the CPU 11.

The RAM 13 temporarily stores data input to and output from the CPU 11. The RAM 13 includes a frame buffer 13A, an intermediate buffer 13B, and a management table 13C.

The DVD drive 14 reads an MPEG encoded video signal from a DVD video disk. The MPEG decoder 16 MPEG decodes the video signal read by the DVD drive 14.

The graphic processing unit 16 constitutes a lower computer for a higher computer composed of the CPU 11, ROM 12, and RAM 13. The graphic processing unit 16 has a graphics-drawing function for drawing various graphic objects representing figures, characters, and other images, on a graphic plane.

The RAM 13 and the graphic processing unit 16 are interconnected not only via the system bus SB but also via a data transfer bus DB.

The DVD player PL has a video output section 17 that outputs a video signal to the display device DSP.

The MPEG decoder 15 and graphic processing unit 16 are connected to the video output section 17 to supply processing results. The graphic processing unit 16 is connected to the video output section 17 via the data transfer bus DB. However, the graphic processing unit 16 may be connected directly to the video output section 17.

The video output section 17 converts the processing results from the MPEG decoder 15 and graphic processing unit 16 into a video signal in, for example, an NTSC format which is suitable for the display device DSP, and outputs the video signal.

The intermediate buffer 13B holds various graphic objects such as figures, characters, and other images as graphic data. The frame buffer 13A holds graphic data transferred from the intermediate buffer 13B. The management table 13C manages the graphic data held in the intermediate buffer 13B by a set (quote) of a predetermined number of pixels.

The graphic processing unit 16 performs a process of storing various graphic objects in the intermediate buffer 13B as graphic data, transferring the graphic data from the intermediate buffer 13B to the frame buffer 13A on the basis of the contents of the management table 13C, and outputting the contents of the frame buffer 13A to the video output section 17 for each vertical scan period corresponding to an image update period.

FIG. 2 shows the configuration of the frame buffer 13A, intermediate buffer 13B, and management table 13C in further detail. For easier understanding, drawing sizes of various graphic objects are made visible with broken lines shown in FIG. 2.

The intermediate buffer 13B includes one or more, for example, six drawing memories GM1 to GM6 each of which defines a graphic plane of an arbitrary size.

In this embodiment, the drawing memory GM1 is used for graphic objects constituting caption and title characters. The drawing memory GM2 is used for graphic objects constituting images such as photographs. The drawing memory GM3 is used for graphic objects constituting geometries such as lines, circles, triangles, and rectangles. The drawing memory GM4 is used for graphic objects constituting sub-video images. The drawing memory GM5 is used for graphic objects constituting images such as photographs preferentially displayed on a display screen closer to a viewer. The drawing memory GM6 is used for graphic objects constituting sub-video images preferentially displayed on the display screen closer to the viewer.

Each of the drawing memories GM1 to GM6 may be provided for plural types of graphic objects. In FIG. 2, each of the drawing memories GM1 to GM6 is illustrated smaller than the frame memory 13A. However, a graphic plane may be defined which, for example, has the same size as that of the frame memory 13A.

The management table 13C includes bitmap memories BM1 to BM6 assigned to the drawing memories GM1 to GM6, respectively. Here, each of the drawing memories GM1 to GM6 defines a graphic plane of size 920 pixels (horizontal direction)×1,080 pixels (vertical direction).

In contrast, for example, a bitmap of size 16 bits (horizontal direction)×8 bits (vertical direction) is set in each of the bitmap memories BM1 to BM6 in order to manage graphic data stored in the drawing memories GM1 to GM6. In this case, the bitmap memories BM1 to BM6 manage the contents of the respective drawing memories GM1 to GM6 by a set (quote) of 120 pixels (horizontal direction)×135 pixels (vertical direction). Specifically, a flag “1” indicates that graphic data for at least one pixel which corresponds to a graphic object is present in the area of the set.

Now, the operation of the graphic processing unit 16 will be described with reference to FIGS. 3 to 13. The graphic processing unit 16 is controlled by the CPU 11, which executes a graphic data drawing program held in the ROM 12. The graphic processing unit 16 performs an operation described below, on, for example, the drawing memory GM1.

The graphic processing unit 16 stores various graphic objects, which should be placed in a graphic plane, in the drawing memory GM1 as graphic data. The graphic processing unit 16 partitions a drawing area, which serves as part of the graphic plane and is occupied by the graphic data, into a plurality of rectangular areas that do not overlap one another. The graphic processing unit 16 then retrieves graphic data from the drawing memory GM1 for each rectangular area.

In this case, the graphic processing unit 16 arranges flags “1” in the bitmap memory BM1 in accordance with the arrangement of a portion of the drawing area which is obtained for each graphic object. The graphic processing unit 16 searches the bitmap memory BM1 for a set of flags “1” consecutively arranged in the vertical and horizontal directions in order to partition the drawing area into a plurality of rectangular areas. The graphic processing unit 16 thus obtains coordinate information on a plurality of rectangular areas from search results. Further, the graphic processing unit 16 minimizes the number of rectangular areas in the search for the set of flags.

In actual drawing, the graphic processing unit 16 is sequentially supplied with requests for drawing of various graphic objects together with coordinate information (x,y,w,h) composed of the horizontal coordinate x and vertical coordinate y of a drawing reference position and the horizontal width w and vertical height h represented as the number of pixels to indicate a drawing size.

The graphic processing unit 16 pre-initializes the entire 16×8-bit bitmap set in the bitmap memory BM1 to “0” as shown in FIG. 3. In this bitmap, for example, an upper left 1 bit coordinate indicates the state of an area of 120 pixels (horizontal direction)×135 pixels (vertical direction) located in the upper left of a graphic plane defined by the drawing memory GM1. An upper right 1 bit coordinate indicates the state of an area of 120 pixels (horizontal direction)×135 pixels (vertical direction) located in the upper right of the graphic plane. A lower left 1 bit coordinate indicates the state of an area of 120 pixels (horizontal direction)×135 pixels (vertical direction) located in the lower left of the graphic plane. A lower right 1 bit coordinate indicates the state of an area of 120 pixels (horizontal direction)×135 pixels (vertical direction) located in the lower right of the graphic plane.

The graphic processing unit 16 subsequently stores the various graphic objects, which should be placed in the graphic plane, in the drawing memory GM1. Upon obtaining coordinate information (x,y,w,h)=(0,0,355,271) for the first graphic object, the graphic processing unit 16 draws a graphic object in the area specified by the coordinate information (x,y,w,h)=(0,0,355,271). The graphic processing unit 16 quantizes the coordinate information (x,y,w,h)=(0,0,355,271) to determine a set range for flags “1” (bmx, bmy, bmw, bmh)=(0,0,3,3). The graphic processing unit 16 sets flags “1” in the bitmap in the bitmap memory BM1 as shown in FIG. 4. Here, bmx indicates the horizontal coordinate of the reference set position; bmy indicates the vertical coordinate of the reference set position; bmw indicates a width represented as the number of flags “1” arranged in the horizontal direction; and bmh indicates a height represented as the number of flags “1” arranged in the vertical direction.

Upon obtaining the next coordinate information (x,y,w,h)=(500,500,518,373) for the next graphic object, the graphic processing unit 16 draws a graphic object in the area specified by the coordinate information (x,y,w,h)=(500,500,518,373). The graphic processing unit 16 quantizes the coordinate information (x,y,w,h)=(500,500,518,373) to determine a set range for flags “1” (bmx, bmy, bmw, bmh)=(4,5,5,3). The graphic processing unit 16 adds flags “1” to the bitmap in the bitmap memory BM1 as shown in FIG. 5.

The graphic processing unit 16 further processes the remaining graphic objects as described above. As a result, the distribution of the entire drawing area is expressed as sets of flags “1” arranged as shown in FIG. 6.

Upon completing all the graphic objects, the graphic processing unit 16 searches the bitmap in the bitmap memory BM1 for sets of flags “1” consecutively arranged in the vertical and horizontal directions.

The search progresses rightward from the upper left bitmap coordinates (0,0). The first time a flag “1” is found, coordinate information (x,y,w,h) on a rectangular area defined using the bitmap coordinates of this flag “1” as a reference set position is set at (0,0,120,135). Here, x denotes the horizontal coordinate of the flag “1” serving as the reference set position; y denotes the vertical coordinate of the flag “1” serving as the reference set position; w denotes the number of horizontal pixels per quote (=120); and h denotes the number of vertical pixels per quote (=135).

Subsequently, the coordinates (1,0) on the right side of the reference set position are examined, and the presence of a flag “1” is confirmed as a result. Thus, w is increased by the number of horizontal pixels (=120). This updates the coordinate information (x,y,w,h) on the rectangular area to (0,0,240,135). Subsequently, the bitmap coordinates (2,0) on the right side of the coordinates (1,0) are examined to confirm the presence of a flag “1”. Thus, w is increased by the number of horizontal pixels (=120). This updates the coordinate information (x,y,w,h) on the rectangular area to (0,0,360,135).

Subsequently, the coordinates (3,0) on the right side of the coordinates (2,0) are examined, and the absence of a flag “1” is confirmed as a result. Thus, the horizontal search is ended and bitmap coordinates (0,1), (1,1), and (2,1) downwardly adjacent to the respective above coordinates are sequentially examined. It is confirmed that a flag “1” is present in each pair of bitmap coordinates (0,1), (1,1), and (2,1). Thus, y is increased by the number of vertical pixels (=135). This updates the coordinate information (x,y,w,h) on the rectangular area to (0,0,360,270).

Subsequently, bitmap coordinates (0,2), (1,2), and (2,2) downwardly adjacent to the respective above coordinates are sequentially examined. It is confirmed that a flag “1” is present in each pair of bitmap coordinates (0,2), (1,2), and (2,2). Thus, y is increased by the number of vertical pixels (=135). This updates the coordinate information (x,y,w,h) on the rectangular area to (0,0,360,405).

Subsequently, bitmap coordinates (0,3), (1,3), and (2,3) downwardly adjacent to the respective above coordinates are sequentially examined. It is confirmed that a flag “1” is not present in any of the pair of coordinates (0,3), (1,3), and (2,3). Thus, a set of flags “1” shown in FIG. 7 is finally obtained, and coordinate information (x,y,w,h)=(0,0,360,405) on the rectangular area defined by this set is registered in the RAM 13 as a first transfer range. (In FIG. 7 and succeeding FIGS. 8 to 13, “0s” are arranged around each searched-for set of flags “1”. However, this is to emphasize the location of the set within the entire bitmap. Accordingly, the bitmap in the bitmap memory BM1 is maintained as shown in FIG. 6.)

Subsequently, a search for a set of flags “1” restarts to progress rightward from the coordinates (3,0). Such a process as described above is executed to finally obtain the set of flags “1” shown in FIG. 8. Then, coordinate information (x,y,w,h)=(1440,0,480,405) on the rectangular area defined by this set is registered in the RAM 13 as a second transfer range.

A subsequent search for a set of flags “1” results in obtaining the set of flags “1” shown in FIG. 9. Then, coordinate information (x,y,w,h)=(1080,405,120,810) on the rectangular area defined by this set is registered in the RAM 13 as a third transfer range.

A subsequent search for a set of flags “1” results in obtaining the set of flags “1” shown in FIG. 10. Then, coordinate information (x,y,w,h)=(600,540,480,405) on the rectangular area defined by this set is registered in the RAM 13 as a fourth transfer range.

A subsequent search for a set of flags “1” results in obtaining the set of flags “1” shown in FIG. 11. Then, coordinate information (x,y,w,h)=(1200,675,720,135) on the rectangular area defined by this set is registered in the RAM 13 as a fifth transfer range.

A subsequent search for a set of flags “1” results in obtaining the set of flags “1” shown in FIG. 12. Then, coordinate information (x,y,w,h)=(1200,810,120,270) on the rectangular area defined by this set is registered in the RAM 13 as a sixth transfer range.

A subsequent search for a set of flags “1” results in obtaining the set of flags “1” shown in FIG. 13. Then, coordinate information (x,y,w,h)=(1320,945,120,135) on the rectangular area defined by this set is registered in the RAM 13 as a seventh transfer range.

The graphic processing unit 16 references the thus registered first to seventh transfer ranges to sequentially retrieve graphic data from the drawing memory for each rectangular area. The graphic processing unit 16 then transfers the retrieved graphic data to the frame buffer 13A.

The graphic processing unit 16 further executes a similar process on the drawing memories GM2 to GM6. The graphic processing unit 16 sequentially retrieves graphic data from the drawing memories GM2 to GM6 for each rectangular area and transfers the retrieved graphic data to the frame buffer 13A.

The graphic data in the drawing memories GM1 to GM6 are stored in the frame buffer 13A during a vertical scan period corresponding to an image update period. The graphic data contains transparency information for transparent display. If the graphic data from the drawing memories GM1 to GM6 partly overlap one another in the frame buffer 13A, the graphic processing unit 16 compares transparency information on the already stored graphic data with transparency information on graphic data to be stored. On the basis of the comparison, the graphic processing unit 16 modifies the graphic data to be stored, and stores the modified data in the frame buffer 13A. The graphic processing unit 16 thus transfers graphic data during each vertical scan period, while outputting the contents of the frame buffer 13A to the video output section 17 as a video signal. The video output section 17 superimposes a video signal from the MPEG decoder 15 on the video signal from the frame buffer 13A to output the superimposed signal to the display device DSP.

As described above, the present embodiment stores various graphic objects, which should be placed in a graphic plane, in each of the drawing memories GM1 to GM6 as graphic data. The present embodiment then partitions a drawing area, which serves as part of the graphic plane and is occupied by the graphic data, into a plurality of rectangular areas that do not overlap one another. The present embodiment subsequently retrieves graphic data from each of the drawing memories GM1 to GM6 for each rectangular area. This eliminates the need for redundant data transfer and makes it possible to minimize the amount of data transferred according to the shape and size of each rectangular area and the total number of the rectangular areas. As a result, the load on a control system such as the graphic processing unit 16 and CPU 11 can be reliably reduced. Moreover, coordinate information on each rectangular area can be obtained during the partitioning of the drawing area. This also makes it possible to avoid a temporary increase in the load on the control system during data transfer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A graphic data retrieving apparatus comprising:
a drawing memory which defines a graphic plane; and
a processing section which retrieves contents of the drawing memory for transfer;
wherein the processing section is configured to store various graphic objects, which should be placed in the graphic plane, in the drawing memory as graphic data, partition a drawing area, which serves as part of the graphic plane and is occupied by the graphic data, into a plurality of rectangular areas which do not overlap one another, and retrieve the graphic data from the drawing memory for each rectangular area.

2. The graphic data retrieving apparatus according to claim 1, wherein the processing section includes a bitmap memory which manages a distribution of the drawing area in the graphic plane by a set of a predetermined number of pixels and is configured to arrange flags in the bitmap memory in accordance with arrangement of a portion of the drawing area obtained for each graphic object.

3. The graphic data retrieving apparatus according to claim 2, wherein the processing section is further configured to search the bitmap memory for a set of flags consecutively arranged in a vertical and horizontal directions in order to partition the drawing area into the plurality of rectangular areas, and to obtain coordinate information on the plurality of rectangular areas on the basis of search results.

4. The graphic data retrieving apparatus according to claim 3, wherein the processing section is configured to minimize the number of rectangular areas in the search for the set of flags.

5. A graphic data retrieving method for graphic data from a drawing memory which defines a graphic plane, the method comprising:
storing various graphic objects, which should be placed in the graphic plane, in the drawing memory as graphic data;
partitioning a drawing area, which serves as part of the graphic plane and is occupied by the graphic data, into a plurality of rectangular areas which do not overlap one another; and
retrieving the graphic data from the drawing memory for each rectangular area.

6. The graphic data retrieving method according to claim 5, further comprising using a bitmap memory which manages a distribution of the drawing area in the graphic plane by a set of a predetermined number of pixels, to arrange flags in the bitmap memory in accordance with arrangement of a portion of the drawing area obtained for each graphic object.

7. The graphic data retrieving method according to claim 6, further comprising searching the bitmap memory for a set of flags consecutively arranged in a vertical and horizontal directions in order to partition the drawing area into the plurality of rectangular areas, and obtaining coordinate information on the plurality of rectangular areas on the basis of search results.

8. The graphic data retrieving method according to claim 7, further comprising minimizing the number of rectangular areas in the search for the set of flags.

9. A graphic data retrieving program for graphic data from a drawing memory which defines a graphic plane, the program causing a computer to execute a process of:
storing various graphic objects, which should be placed in the graphic plane, in the drawing memory as graphic data;
partitioning a drawing area, which serves as part of the graphic plane and is occupied by the graphic data, into a plurality of rectangular areas which do not overlap one another; and
retrieving the graphic data from the drawing memory for each rectangular area.

10. The graphic data retrieving program according to claim 9, causing the computer to execute a process of using a bitmap memory which manages a distribution of the drawing area in the graphic plane by a set of a predetermined number of pixels, to arrange flags in the bitmap memory in accordance with arrangement of a portion of the drawing area obtained for each graphic object.

11. The graphic data retrieving program according to claim 10, causing the computer to execute a process of searching the bitmap memory for a set of flags consecutively arranged in a vertical and horizontal directions in order to partition the drawing area into the plurality of rectangular areas and obtaining coordinate information on the plurality of rectangular areas on the basis of search results.

12. The graphic data retrieving program according to claim 11, causing the computer to execute a process of minimizing the number of rectangular areas in the search for the set of flags.
